(19) United States
(12) Patent Application Publication
(10) Pub. No.: US 2020/0146320 A1
(43) Pub. Date: May 14, 2020

(54) NUTRITION BAR FOR INTERMITTENT FASTING-MIMICKING

(71) Applicant: L-NUTRA, Los Angeles, CA (US)

(72) Inventor: Valter D. LONGO, Playa Del Rey, CA (US)

(21) Appl. No.: 16/680,911

(22) Filed: Nov. 12, 2019

Related U.S. Application Data
(60) Provisional application No. 62/758,033, filed on Nov. 9, 2018.

(51) Int. Cl. A23L 25/00; A23L 21/25; A23L 19/00; A23L 33/15; A23L 33/105; A23L 33/115; A23L 33/22

(52) U.S. Cl. CPC A23L 25/20; A23L 21/25; A23L 19/01; A23V 2002/00; A23L 33/105; A23L 33/115; A23L 33/22; A23L 33/15

(57) ABSTRACT

A nutrition bar to be used for an intermittent fasting-mimicking meal includes any combination of macadamia nuts; honey; pecans; almonds; almond butter; coconut; inulin; flax seeds; coconut oil; cocoa derivatives; and coconut flour. Characteristically, the nutrition bar of 40% or more fat provides from 100 to 300 kcal of which 40 percent kcal are from fats and 10 to 30 percent kcal are from carbohydrates with less than 10 grams of protein.

### CROSS-REFERENCE TO RELATED APPLICATIONS

This application claims the benefit of U.S. provisional application Ser. No. 62/758,033 filed Nov. 9, 2018, the disclosure of which is hereby incorporated in its entirety by reference herein.

### TECHNICAL FIELD

The present invention, in general, relates to a nutrition bar component of a fasting-mimicking diet that provides nutrients to a subject. In another aspect, the present invention relates to a nutrition bar containing 40% or more fat.

### BACKGROUND

Recently, fasting-mimicking diets have been found to provide a number of health benefits. For example, fasting-mimicking diets have been found to be useful in improving metabolic health including weight, age-related markers, inflammatory markers, metabolic syndrome, diabetes, and hypertension; as well as alleviating symptoms of chemotherapy, and Alzheimer's disease.

U.S. patent application Ser. No. 15/432,803 provides a diet package that is designed to provide daily food components to a subject in accordance with a fasting-mimicking diet. This diet package includes various components such as soup mixes, nutrition bars, and crackers, all which mimic fasting. Although the prior art fasting-mimicking diet components work well, compositions with improved formulation and appeal taste properties are desired.

Accordingly, there is a need for novel nutrition bars to be used in intermittent fasting or the fasting-mimicking diet.

### SUMMARY

Against this prior art background, a nutrition bar for fasting or a fasting-mimicking diet is provided. The nutrition bar includes any combination of the following macadamia nuts; honey; pecans; almonds; almond butter, coconut; inulin; flax seeds; coconut flour; coconut oil; cocoa derivatives. The nutrition bar provides from 100 to 300 kcal of which at least 40 percent kcal are from fats and 10 to 30 percent kcal are from carbohydrates with less than 10 grams of protein. It should be appreciated that the nutrition bar provides 25 to 38 weight percent of the daily recommended dietary value (“the daily value”) (e.g., the nutritional requirements based on a 2000 kcal per day diet used by the United Kingdom Department of Health and the European Union's European Food Safety Authority on Nov. 1, 2019) of fat and 1 to 10 weight percent kcal of the daily recommended dietary value for carbohydrates. In a refinement, the daily value is 65 g fat and 280 g carbohydrate.

In another aspect, a method of intermittent fasting is provided. The method includes a step of fasting by a subject for 12 up to 24 hours only intaking a nutrition bar for a predetermined number of meals. The details of the nutrition bar are set forth herein. In particular, the nutrition bar includes any combination of macadamia nuts; honey; pecans; almonds; almond butter; coconut; inulin; cocoa derivatives; flax seeds; and coconut flour. Characteristically, the nutrition bar provides from 100 to 300 kcal of which 40 percent kcal are from fats and 10 to 30 percent kcal are from carbohydrates with less than 10 grams of protein.

In another variation, a method for administering a fasting-mimicking diet is provided. The method includes a step of identifying a subject in need of a fasting-mimicking diet. The subject is then provided with a fasting-mimicking diet having less than about 10 percent calories from protein sources. The fasting-mimicking diet provides at most 50% of the normal caloric intake of the subject with at least 50% of the kilocalories being derived from fat. Characteristically, the fasting-mimicking diet includes a nutrition bar as set forth above. As set forth above, the nutrition bar includes any combination of macadamia nuts; honey; pecans; almonds; almond butter, coconut; inulin; cocoa derivatives; flax seeds; and coconut flour. Characteristically, the nutrition bar provides from 100 to 300 kcal of which 40 percent kcal are from fats and 10 to 30 percent kcal are from carbohydrates with less than 10 grams of protein.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1 provides exemplary nutritional facts for the fasting nutrition bar.

FIG. 2 provides exemplary nutritional facts for the fasting nut and cocoa derivatives-containing nutrition bar.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

In the examples set forth herein, compositions, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

The term “subject” refers to a human or animal, including all mammals such as primates (particularly higher primates), sheep, dog, rodents (e.g., mouse or rat), guinea pig, goat, pig, cat, rabbit, and cow.

The term “fasting-mimicking and enhancing diet” means a diet that mimics the effects of fasting typically by providing a subject with at most 50% of their normal caloric intake. The term “fasting-mimicking and enhancing diet” is sometimes simply referred to as a “fasting-mimicking diet.” These diets include those diets that have been referred to as fasting-mimicking diets. Examples of useful fasting-mimicking and enhancing diets and methods for monitoring the effects of these diets on markers such as IGF-1 and IGFBP1 in the context of the present invention are set forth in U.S. Pat. Pub. No. 2014/0328863 published Nov. 6, 2014; U.S. Pat. Pub. No. 2015/0133370 published May 14, 2015; U.S. Pat. Pub. No. 2011/0118528 published May 19, 2011; U.S. Pat. Pub. No. 2013/0045215 published Feb. 21, 2013; U.S. Pat. Pub. No. 2013/0316948 published Nov. 28, 2013; U.S. Pat. No. 10,015,980 issued Jul. 10, 2018; U.S. Pat. No. 9,237,761 issued Jan. 19, 2016; U.S. Pat. No. 9,386,790 issued Jul. 12, 2016; U.S. Pat. No. 10,172,839 issued Jan. 8, 2019; the entire disclosure of these patent applications is hereby incorporated by reference. The fasting-mimicking diet set forth in U.S. Pat. Nos. 10,015,980 and 9,237,761 are found to be particularly useful in the present invention.

In an embodiment of the present invention, a nutrition bar to be used in a fasting-mimicking diet is provided. Sometimes, the “nutrition bar” is referred to as a “fasting bar.” The nutrition bar includes any combination of the following: macadamia nuts; pecans; almonds; almond meal; almond butter (formed from raw or dried onions); coconut; inulin; flax seeds; cocoa derivatives; and coconut flour. In a refinement, the nutrition bar includes any 3, 4, 5, 6, 7, 8, 9 or 10 of these components. In a variation, the nutrition bar includes macadamia nuts; honey; pecans; almonds or almond meal; almond butter, inulin; flax seeds or flaxseed meal; and coconut flour. In a refinement, the nutrition bar further includes coconuts and/or coconut oil. In a further refinement, the nutrition bar further includes cocoa derivatives. It should be appreciated that the recitation of each component includes part of such components that can be ground, chopped, and/or dried. For examples, the recitation of macadamia nuts; honey; pecans; almonds; coconut; and flax seeds include parts of such components, i.e., nuts and coconuts without the shells.

In a variation, the nutrition bar is a fasting-mimicking ‘meal replacement’ bar or a fasting-mimicking ‘light meal’ bar that can replace breakfast, lunch or dinner.

Typically, the almond meal and/or the other nut components can be roasted (e.g., in a convection oven). In a refinement, the cocoa derivates include cocoa mass, cocoa powder, cocoa butter, cocoa nibs, and combinations thereof. In a refinement, the nutrition bar includes a component selected from the group consisting of oleoresin, rosemary, vanilla powder, and combinations thereof. In a refinement, each nutrition bar provides from 100 to 300 kcal. Characteristically, the nutrition bar provides 25 to 38 weight percent of the daily recommended dietary value (e.g., the nutritional requirements based on a 2000 kcal per day diet used by the United Kingdom Department of Health and the European Union's European Food Safety Authority on Nov. 1, 2019) of fat and 1 to 10 weight percent kcal of the daily recommended dietary value for carbohydrates.

In some refinements, the nutrition bar includes fat in an amount of at least, in increasing order of preference, 40 weight percent, 45 weight percent, 50 weight percent, 60 weight percent, or 70 weight percent and fat in an amount of at most, in increasing order of preference, 65 weight percent, 75 weight percent, 85 weight percent, 90 weight percent, or 95 weight percent. In a refinement, the nutrition bar includes carbohydrates in an amount of at least, in increasing order of preference, 1 weight percent, 5 weight percent, 10 weight percent, 12 weight percent, or 15 weight percent and carbohydrates in an amount of at most, in increasing order of preference, 30 weight percent, 25 weight percent, 22 weight percent, 20 weight percent, or 18 weight percent. Unless stated to the contrary all percentages are weight percentages of the total weight of the nutrition bar. In another refinement, each nutrition bar includes fat in an amount of at least, in increasing order of preference, 1 gram, 2 grams, 3 grams, 4 grams, or 5 grams, and fat in an amount of at most, in increasing order of preference, 10 grams, 12 grams, 13 grams, 14 grams, or 15 grams. In another refinement, each nutrition bar includes carbohydrates in an amount of at least, in increasing order of preference, 1 gram, 2 grams, 5 grams, 8 grams, or 10 grams, and carbohydrates in an amount of at most, in increasing order of preference, 20 grams, 18 grams, 15 grams, 13 grams, or 12 grams. In another refinement, each nutrition bar includes protein in an amount of at least, in increasing order of preference, 1 gram, 2 grams, 3 grams, 4 grams, or 5 grams, and protein in an amount of at most, in increasing order of preference, 25 grams, 20 grams, 15 grams, 10 grams, or 8 grams. It should be appreciated that all of the variations and refinements set forth herein can be combined.

In a variation, the nutrition bar further includes salt (e.g., sea salt). Sea salt refers to the salt obtained from the evaporation of seawater. The principal component of sea salt is sodium chloride less than 0.2 to 10% of other salts such as calcium, potassium, and magnesium salts of chloride and sulfate. In a refinement, the nutrition bar further may, or may not, include coconut oil. Characteristically, the components of the nutrition bar are held together by thick viscous liquid components such as the almond butter, honey, and coconut. In this regard, the almond butter is the most viscous component (e.g., an almond butter paste) thereby providing most of the cohesion of the components together.

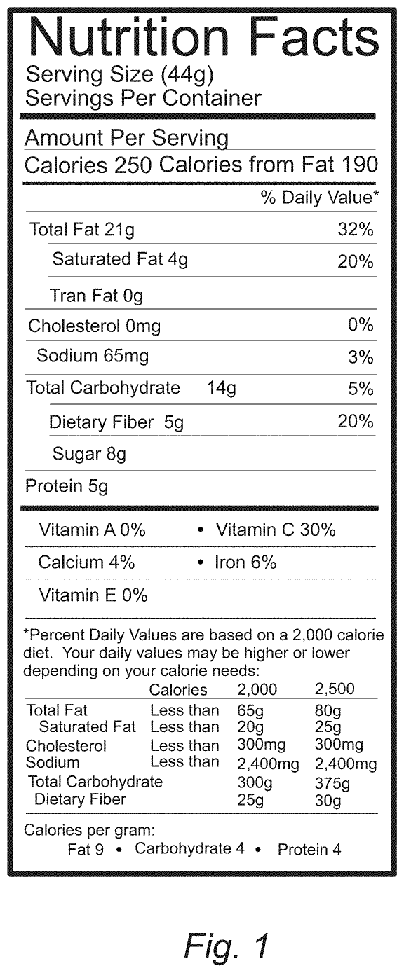

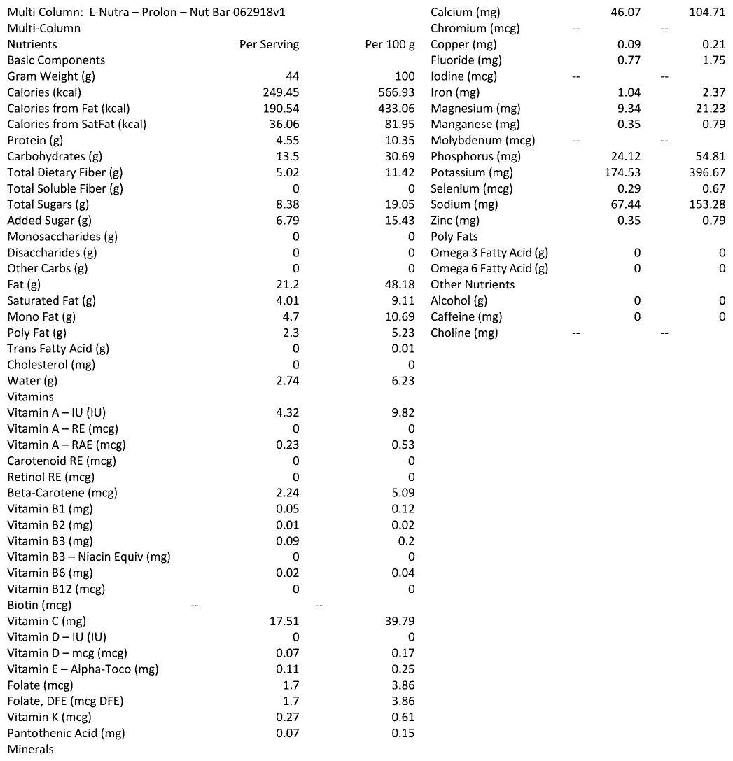

In a refinement, the nutrition bar further includes flavoring, mixed tocopherols, citric acid anhydrous, and ascorbic acid. FIGS. 1 and 2 provide exemplary nutritional facts for the nutrition bar. In a variation, practice is within +/−20 percent of the values set forth in FIGS. 1 and 2 truncated to 2 significant values. Tables 1, 2, 3, 4 and 5 provided exemplary composition ranges. In some variations, the endpoints of the ranges set forth in Tables 1, 2, 3, 4, or 5 can be multiplied by 1.5 or 2. Typically, the nutrition bar weighs from 40 to 50 grams or from 90 to 110 grams.

TABLE 1
Nutrition bar composition 1.

| Ingredient | Weight percent range |
|---|---|
| Macadamia nuts, dried, whole | 17.6-26.5 |
| Honey | 15.2-22.7 |
| Pecans, chopped | 12.3-18.5 |
| Almond meal, roasted conv. | 10.4-15.6 |
| Almond butter | 9.2-13.8 |
| Coconut, dried, unsweetened | 5.2-7.8 |
| Inulin, Oligofructose | 4.1-6.2 |
| Flax seeds, ground | 3.3-5.0 |
| Coconut oil | 0.9-1.3 |
| Coconut flour | 1.0-1.6 |
| Sea salt | 0.3-0.5 |
| Flavor, natural | 0.3-0.5 |
| Mixed tocopherols | 0.0-0.1 |
| Citric acid, anhydrous | 0.033-0.049 |
| Ascorbic acid | 0.033-0.049 |

TABLE 2
Nutrition bar composition 2.

| Ingredient | Weight Percent |
|---|---|
| Macadamia nuts, dried | 15.1-22.6 |
| Honey | 13.9-20.8 |
| Pecans, chopped | 13.2-19.8 |
| Almonds, chopped | 12.2-18.3 |
| Almond butter | 7.5-11.2 |
| Cocoa derivates (cocoa mass, cocoa | 4.5-6.8 |
| powder, cocoa butter, and cocoa nibs) | |
| Coconut, dried, unsweetened | 4.2-6.3 |
| Inulin, Oligofructose | 3.6-5.5 |
| Flax seeds, ground | 3.5-5.3 |
| Coconut oil | 0.9-1.4 |
| Coconut Hour | 0.7-1.1 |
| Sea salt | 0.3-0.4 |
| Natural Flavor agents (no nutritional | 0.3-0.4 |
| contribution) | |
| Mixed tocopherols | 0.0-0.1 |
| Citric acid, anhydrous | 0.033-0.049 |
| Ascorbic acid | 0.033-0.049 |

TABLE 3
Nutrition bar composition 3.

| Ingredient | Weight percent range |
|---|---|
| Macadamia nuts, dried, whole | 17.6-26.5 |
| Honey | 15.2-22.7 |
| Pecans, chopped | 12.3-18.5 |
| Almond meal, roasted conv. | 10.4-15.6 |
| Almond butter | 9.2-13.8 |
| Coconut, dried, unsweetened | 5.2-7.8 |
| Inulin | 4.1-6.2 |
| Flax seeds, ground | 3.3-5.0 |
| Coconut oil | 0-1.3 |
| Coconut flour | 1.0-1.6 |
| Sea salt | 0.3-0.5 |
| Flavor agents (natural) | 0.3-0.5 |
| Mixed tocopherols | 0.0-0.1 |
| Citric acid, anhydrous | 0.033-0.049 |
| Ascorbic acid | 0.033-0.049 |

TABLE 4
Nutrition bar composition 4.

| Ingredient | Weight Percent |
|---|---|
| Macadamia nuts, dried | 15.1-22.6 |
| Honey | 13.9-20.8 |
| Pecans, chopped | 13.2-19.8 |
| Almonds, chopped | 12.2-18.3 |
| Almond butter | 7.5-11.2 |
| Cocoa derivatives (cocoa mass, | 4.5-6.8 |
| cocoa powder, cocoa butter, | |
| and cocoa nibs) | |
| Coconut, dried, unsweetened | 4.2-6.3 |
| Inulin | 3.6-5.5 |
| Flax seeds, ground | 3.5-5.3 |
| Coconut oil | 0.0-1.4 |
| Coconut flour | 0.7-1.1 |
| Sea salt | 0.3-0.4 |
| Flavor agents (no nutritional | 0.3-0.4 |
| contribution) | |
| Mixed tocopherols | 0.0-0.1 |
| Citric acid, anhydrous | 0.033-0.049 |
| Ascorbic acid | 0.033-0.049 |

TABLE 5
Nutrition bar composition 5.

| Ingredient | Weight Percent |
|---|---|
| Almond Butter | 7-11 |
| Macadamia Nuts | 16-24 |
| Oleoresin (Rosemary) | 0.04-0.06 |
| Inulin | 11-18 |
| Honey | 7-10 |
| Vanilla Powder | 0.5-1 |
| Salt, Sea | 0.3-0.4 |
| Flaxseed Meal | 4-6 |
| Almond Meal | 13-19 |
| Coconut Flour | 7-10 |
| Pecans (e.g., pieces) | 13-20 |

The nutrition bar is formulated to mimic fasting to improve metabolic health related to body mass index (BMI), cholesterol, and glycemic index in the blood. The nutrition bar is formulated to simulate one or more meals per day as part of an intermittent fasting-mimicking diet. The nutrition bar may be used in conjunction with the practice of time restricted feeding (also known as time restricted eating). Time restricted feeding has been shown to have many health benefits including improving insulin sensitivity, blood pressure, and oxidative stress. See e.g. Sutton et al., Cell Metabolism 27, 1212-1221, Jun. 5, 2018; Amandine et al, Cell Metab., 20(6): 991-1005, 2014 Dec. 2; Longo, Cell Metab. 23(6):1048-1059, Jun. 14, 2016: Shubhroz, Cell Metab, 22(5):789-798, Nov. 3, 2015. The nutrition bar allows an individual to extend overnight fasting without the health risks of skipping breakfast. See e.g. Sharma K et al., QJM, 111(10):715-719, 2018 Oct. 1; Peñalvo et al., JACC, 70(15):1833-1842, 2017 Oct. 10; the entire disclosures of these publications are hereby incorporated by reference.

The nutrition bar also complements daily nutrition of an individual. The nutrition bar is preferably consumed as a meal. The individual consumes the meal once or twice or three times per day when practicing time restricted feeding. In general, an individual will eat the nutrition bar to achieve 12, 18 or 24-hours of intermittent fasting. Time restricted feed compresses the amount of time that an individual consumes calories and increases the amount of time an individual spends fasting.

In another embodiment, the nutrition bar may be manufactured by weighing and pre-mixing (if required) all raw ingredients. Ingredients are placed in a large container and blended to ensure consistent mixing. Once ingredients are mixed, the blend is pressed and compressed (slabbed) to form a flat sheet of the mixed ingredients. In a refinement, the ingredients will adhere together and can at least partially react with each other. The sheet of mixed ingredients is then cut into predetermined sizes and allowed to dry to form a completed nutrition bar. The nutrition bar may then be packaged in foil sleeves and sealed via cold or heat sealing.

As set forth above, the nutrition bar is advantageously integrated into a fasting-mimicking diet as set forth in U.S. Pat. Pub. No. 2018/0228198 published Aug. 16, 2018, the entire disclosure of which is hereby incorporated by reference. Typically, a diet package for administering a fasting-mimicking diet is provided that can include the nutrition bar set forth above in place of the nutrition bar set forth therein. The fasting-mimicking diet package provides daily meal portions for a predetermined number of days. Typically, the predetermined number of days is from 1 to 10 days (i.e., 1, 2, 3, 4, 5, 6, 7, 8, 9, or 10 days). In a particularly useful variation, the predetermined number of days is 5 or 6 days. In some variations, the fasting-mimicking diets set forth herein provide a subject at most, in increasing order of preference, 75%, 50%, 40%, 30%, or 10% of the subject's normal caloric intake or the daily recommended caloric intake for a subject. In a refinement, the fasting-mimicking diet provides at least, in increasing order of preference, 5%, 10%, or 20% of the subject's normal caloric intake or the daily recommended caloric intake for a subject. However, if the fasting-mimicking diet composition is maintained, based on our current and previous findings, partial disease prevention and treatment effects are anticipated even if 100% of the normal caloric intake is provided to subjects. The subject's normal caloric intake is the number of kcal that the subject consumes to maintain his/her weight. The subject's normal caloric intake may be estimated by interviewing the subject or by consideration of a subject's weight. As a rough guide, subject's normal caloric intake is on average 2600 kcal/day for men and 1850 kcal/day for women. In certain instances, the fasting-mimicking diet provides the subject with 700 to 1200 kcal/day. In a particularly useful refinement, the fasting-mimicking diet provides a male subject of average weight with about 1100 kcal/day and a female subject of average weight with 900 kcal/day. In some variation, the diet from the diet package is administered on consecutive days. In another variation, the daily meal portions are provided for only one day a week for at least a month.

In one embodiment, as set forth above, the fasting-mimicking diet package provides daily meal portions for a predetermined number of days. The fasting-mimicking diet package includes a kale cracker composition, a first vegetable soup composition, a mushroom soup composition, a tomato soup composition, a quinoa-containing minestrone soup composition, a bean-containing minestrone soup composition, and a pumpkin soup composition. Characteristically, the daily meal portions are packaged into meal servings or into a total daily serving to be divided into meals. In a refinement, the fasting-mimicking diet package further includes a nutrition bar as set forth above (e.g. a cocoa-containing nutrition bar), a first olive-containing composition, a first vegetable broth composition, a tea composition that includes spearmint, an energy drink composition, a micro-nutritional composition, and algal oil composition. In a further refinement, the fasting-mimicking diet package further includes a second olive-containing composition, a second vegetable broth composition, a tea composition that includes spearmint, lemon peel and lemongrass, and a tea composition that includes hibiscus.

In a variation of the embodiments set forth above, the fasting-mimicking diet package includes daily meal portions that provide less than 40 grams of sugar for day 1, less than 30 grams of sugar for days 2 to 5 and any remaining days, less than 28 grams of protein for day 1, less than 18 grams of protein for days 2 to 5 and any remaining days, 20-30 grams of monounsaturated fats or more to reach the desired caloric intake (i.e., a predetermined caloric intake) for day 1, 6-10 grams of polyunsaturated fats or more to reach the desired caloric intake for day 1, 2-12 grams of saturated fats or more to reach the desired caloric intake for day 1, 10-15 grams of monounsaturated fats or more to reach the desired caloric intake for days 2 to 5 and any remaining days, 3-5 grams of polyunsaturated fats or more to reach the desired caloric intake for days 2 to 5 and any remaining days, 1-6 grams of saturated fats or more to reach the desired caloric intake for days 2 to 5, or any remaining days, and a micronutrient composition on each day and any remaining days.

In another variation of the embodiments set forth above, the fasting-mimicking diet package includes daily meal portions which provide 8-10 kcal per kilogram body weight for each diet day. In this variation, the fasting-mimicking diet provides less than 30 grams of sugar for each diet day, less than 18 grams of protein for each diet day, 9-15 grams of monounsaturated fats or more to reach the desired caloric intake for each diet day, and 2.5-4.5 grams of polyunsaturated fats or more to reach the desired caloric intake for each diet day and 1-5.5 grams of saturated fats or more to reach the desired caloric intake for each diet day. Higher levels of the fats listed above can be provided for higher FMD formulation providing up tol00% of the normal caloric intake to subjects.

In another variation, a method for administering a fasting-mimicking diet is provided. The method includes a step of identifying a subject in need of a fasting-mimicking diet. A subject in need of the fasting-mimicking diet may have diabetes, metabolic syndrome, diabetes, and hypertension, and/or Alzheimer's disease. Additional subject in need of the fasting-mimicking diet may be obese subjects in need of weight reduction or adjustment of their lipid panels or subjects having cancer and undergoing chemotherapy. The subject is then provided with a fasting-mimicking diet having less than about 10 percent calories from protein sources. In a refinement, the fasting-mimicking diet is provided in the form of a diet package as set forth above. The fasting-mimicking diet provides at most 50% of the normal caloric intake of the subject with at least 50% of the kilocalories being derived from fat. Characteristically, the fasting-mimicking diet includes a nutrition bar as set forth above. As set forth above, the nutrition bar includes any combination of macadamia nuts; honey; pecans; almonds; almond butter, coconut; inulin; cocoa derivatives; flax seeds; and coconut flour. Characteristically, the nutrition bar provides from 100 to 300 kcal of which 40 percent kcal are from fats and 10 to 30 percent kcal are from carbohydrates with less than 10 grams of protein. In a refinement, the fasting-mimicking diet provides the subject with from about 300 to 1200 kcal per day. In another refinement, the method further includes a step of monitoring glucose and/or IGF-1 levels of the subject.

In a refinement, the fasting-mimicking diet is administered to the subject for a first time period from 1 day to 14 days (i.e., 1, 2, 3, 4, 5, 6, 7, 8, 9, 10, 11, 12, 13, or 14 days).

In some refinements, the fasting-mimicking diet provides from 3 to 7 kilocalories per pound of the subject for each day of the fasting-mimicking diet. In a further refinement, the fasting-mimicking diet provides from 4.5 to 7 kilocalories per pound of the subject on day 1 of the fasting-mimicking diet and 3-5 kilocalories per pound of the subject on each of the other days of the fasting-mimicking diet.

Typically, the method further includes a step of administering a second diet to the subject for a second time period following the low protein diet wherein the second diet provides an overall calorie consumption that is within 20 percent of a subject's normal calorie consumption for 25 to 26 days. In another variation, the fasting-mimicking diet includes an amino acid specific supplement. Typically, the supplement provides excess levels of non-essential amino acids to be consumed for a period of 5 to 7 days together with very low protein amounts or no protein diet. In a refinement, the low protein diet is alternated with a normal protein diet. In such variations, the low protein diet is provided for 7 days every 2 weeks to 2 months with a normal diet of 1 to 7 weeks in between. In a refinement, the amino acid specific supplement substantially excludes the following amino acids: isoleucine, leucine, lysine, methionine, phenyalanine, threonine, tryptophan, valine, and arginine. In this context, “substantially excludes” means that the total of the excluded amino acids is less than, increasing order of preference, 5 weight percent, 3 weight percent, 1 weight percent, and 0.5 weight percent of the total weight of the subject's diet. Instead, the amino acid specific diet provides one or more of the following amino acids as a source of nitrogen: alanine, aspartic acid, cysteine, glutamic acid, glycine, histidine, proline, serine, and tyrosine.

In the maintenance of benefits from the Fasting-mimicking Diet, the nutrition bar set forth above is used as a fasting-mimicking ‘meal replacement’ bar or a fasting-mimicking ‘light meal’ bar that can replace breakfast and/or lunch and/or dinner. In particular, the nutrition bar set forth above can be used for intermittent fasting wherein a subject fasts for 12 to 24 hours but for only intaking the nutrition bar for a predetermined number of meals. As set forth above, the nutrition bar includes any combination of macadamia nuts; honey; pecans; almonds; almond butter; coconut; inulin; cocoa derivatives; flax seeds; and coconut flour. Characteristically, the nutrition bar provides from 100 to 300 kcal of which 40 percent kcal are from fats and 10 to 30 percent kcal are from carbohydrates with less than 10 grams of protein. In a refinement, the predetermined number of meals is 1, 2, or 3 meals.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A nutrition bar for fasting or a fasting-mimicking diet comprising:
macadamia nuts;
honey;
pecans;
almonds or almond meal;
almond butter;
inulin;
flax seeds or flaxseed meal; and
coconut flour, the nutrition bar provides from 100 to 300 kcal of which 40 percent kcal are from fats and 10 to 30 percent kcal are from carbohydrates with less than 10 grams of protein.

2. The nutrition bar of claim 1, wherein the nutrition bar provides 25 to 38 weight percent of the daily recommended dietary value of fat and 1 to 10 weight percent kcal of the daily recommended dietary value for carbohydrates.

3. The nutrition bar of claim 1 further comprising coconuts and/or coconut oil.

4. The nutrition bar of claim 1 further cocoa derivatives.

5. The nutrition bar of claim 4, wherein the cocoa derivatives include a component selected from the group consisting of cocoa mass, cocoa powder, cocoa butter, cocoa nibs, and combinations thereof.

6. The nutrition bar of claim 1 further comprising sea salt.

7. The nutrition bar of claim 1 further comprising flavoring, mixed tocopherols, citric acid anhydrous, and ascorbic acid.

8. The nutrition bar of claim 1 wherein
macadamia nuts are present in an amount from about 17.6 to 26.5 weight percent of the total weight of the nutrition bar,
honey is present in an amount from about 15.2 to 22.7 weight percent of the total weight of the nutrition bar,
pecans are present in an amount from about 12.3 to 18.5 weight percent of the total weight of the nutrition bar;
almond meal is present in an amount from about 10.4 to 15.6 weight percent of the total weight of the nutrition bar;
almond butter is present in an amount from about 9.2 to 13.8 weight percent of the total weight of the nutrition bar;
cocoa derivatives present in an amount from about 4.5 to 6.8 weight percent of the total weight of the nutrition bar;
coconut is present in an amount from about 5.2 to 7.8 weight percent of the total weight of the nutrition bar;
inulin is present in an amount from about 4.1 to 6.2 weight percent of the total weight of the nutrition bar;
flax seeds are present in an amount from about 3.3 to 5.0 weight percent of the total weight of the nutrition bar;
coconut oil may be present in an amount from about 0.0 to 1.3 weight percent of the total weight of the nutrition bar;
coconut flour is present in an amount from about 1.0 to 1.6 weight percent of the total weight of the nutrition bar;
sea salt is present in an amount from about 0.3 to 0.4 weight percent of the total weight of the nutrition bar;
flavoring is present in an amount from about 0.3 to 0.5 weight percent of the total weight of the nutrition bar;
mixed tocopherols are present in an amount from about 0.0 to 0.1 weight percent of the total weight of the nutrition bar,
citric acid, anhydrous are present in an amount from about 0.033 to 0.049 weight percent of the total weight of the nutrition bar; and
ascorbic acid is present in an amount from about 0.033 to 0.049 weight percent of the total weight of the nutrition bar.

9. The nutrition bar of claim 1 wherein
macadamia nuts are present in an amount from about 15.1 to 22.6 weight percent of the total weight of the nutrition bar,
honey is present in an amount from about 13.9 to 20.8 weight percent of the total weight of the nutrition bar;
pecans are present in an amount from about 13.2 to 19.8 weight percent of the total weight of the nutrition bar;
chopped almond are present in an amount from about 12.2 to 18.3 weight percent of the total weight of the nutrition bar,
almond butter is present in an amount from about 7.5 to 11.2 weight percent of the total weight of the nutrition bar;
coconut is present in an amount from about 4.5 to 6.8 weight percent of the total weight of the nutrition bar;
inulin is present in an amount from about 3.6 to 5.5 weight percent of the total weight of the nutrition bar,
flax seeds are present in an amount from about 3.5 to 5.3 weight percent of the total weight of the nutrition bar;
coconut oil is present in an amount from about 0.0 to 1.4 weight percent of the total weight of the nutrition bar;
coconut flour is present in an amount from about 0.7 to 1.1 weight percent of the total weight of the nutrition bar;
sea salt is present in an amount from about 0.3 to 0.4 weight percent of the total weight of the nutrition bar;
flavoring is present in an amount from about 0.3 to 0.4 weight percent of the total weight of the nutrition bar;
mixed tocopherols is present in an amount from about 0.0 to 0.1 weight percent of the total weight of the nutrition bar;
citric acid, anhydrous are present in an amount from about 0.033 to 0.049 weight percent of the total weight of the nutrition bar; and
ascorbic acid is present in an amount from about 0.033 to 0.049 weight percent of the total weight of the nutrition bar.

10. The nutrition bar of claim 1 wherein
macadamia nuts are present in an amount of 17.6 to 26.5 weight percent of the total weight of the nutrition bar;
honey 15.2 to 22.7 weight percent of the total weight of the nutrition bar;
pecans are present in an amount of 12.3 to 18.5 weight percent of the total weight of the nutrition bar;
almond meal are present in an amount from about 10.4 to 15.6 weight percent of the total weight of the nutrition bar,
almond butter is present in an amount from about 9.2 to 13.8 weight percent of the total weight of the nutrition bar;
coconuts are present in an amount from about 5.2 to 7.8 weight percent of the total weight of the nutrition bar;
inulin is present in an amount from about 4.1 to 6.2 weight percent of the total weight of the nutrition bar,
flax seeds are present in an amount from about 3.3 to 5.0 weight percent of the total weight of the nutrition bar;
coconut oil is present in an amount from about 0 to 1.3 weight percent of the total weight of the nutrition bar,
coconut flour is present in an amount from about 1.0 to 1.6 weight percent of the total weight of the nutrition bar;
sea salt is present in an amount from about 0.3 to 0.5 weight percent of the total weight of the nutrition bar;
mixed tocopherols are present in an amount from about 0.0 to 0.1 weight percent of the total weight of the nutrition bar;
citric acid is present in an amount from about 0.033 to 0.049 weight percent of the total weight of the nutrition bar; and
ascorbic acid is present in an amount from about 0.033 to 0.049 weight percent of the total weight of the nutrition bar.

11. The nutrition bar of claim 1 wherein:
macadamia nuts are present in an amount from 15.1 to 22.6 weight percent of the total weight of the nutrition bar;
honey is present in an amount from 13.9 to 20.8 weight percent of the total weight of the nutrition bar;
pecans are present in an amount from 13.2 to 19.8 weight percent of the total weight of the nutrition bar,
almonds are present in an amount from 12.2 to 18.3 weight percent of the total weight of the nutrition bar,
almond butter is present in an amount from 7.5 to 11.2 weight percent of the total weight of the nutrition bar;
cocoa derivatives are present in an amount of 4.5 to 6.8 weight percent of the total weight of the nutrition bar,
coconut is present in an amount from 4.2 to 6.3 weight percent of the total weight of the nutrition bar;
inulin is present in an amount from 3.6 to 5.5 weight percent of the total weight of the nutrition bar,
flax seeds are present in an amount from 3.5 to 5.3 weight percent of the total weight of the nutrition bar,
coconut oil is present in an amount from 0.0 to 1.4 weight percent of the total weight of the nutrition bar,
coconut flour is present in an amount from 0.7 to 1.1 weight percent of the total weight of the nutrition bar,
sea salt is present in an amount from 0.3 to 0.4 weight percent of the total weight of the nutrition bar;
mixed tocopherols are present in an amount of 0.0 to 0.1 weight percent of the total weight of the nutrition bar;
citric acid is present in an amount from 0.033 to 0.049 weight percent of the total weight of the nutrition bar, and
ascorbic acid is present in an amount from 0.033 to 0.049 weight percent of the total weight of the nutrition bar.

12. The nutrition bar of claim 1 wherein:
almond butter is present in an amount from 7 to 11 weight percent of the total weight of the nutrition bar,
macadamia nuts is present in an amount from 16 to 24 weight percent of the total weight of the nutrition bar;
oleoresin is present in an amount from 0.04 to 0.06 weight percent of the total weight of the nutrition bar,
inulin is present in an amount from 11 to 18 weight percent of the total weight of the nutrition bar;
honey is present in an amount from 7 to 10 weight percent of the total weight of the nutrition bar;
vanilla powder is present in an amount from 0.5 to 1 weight percent of the total weight of the nutrition bar;
salt is present in an amount from 0.3 to 0.4 weight percent of the total weight of the nutrition bar,
flaxseed meal is present in an amount from 4 to 6 weight percent of the total weight of the nutrition bar,
almond meal is present in an amount from 13 to 19 weight percent of the total weight of the nutrition bar,
coconut flour is present in an amount from 7 to 10 weight percent of the total weight of the nutrition bar, and
pecans are present in an amount from 13 to 20 weight percent of the total weight of the nutrition bar.

13. The nutrition bar of claim 1 wherein the almonds are chopped almonds, almond meal, or a combination thereof.

14. The nutrition bar of claim 1 wherein the nutrition bar weighs from 40 to 50 grams.

15. The nutrition bar of claim 1 wherein the nutrition bar weighs from 90 to 110 grams.

16. A fasting-mimicking diet package including the nutrition bar of claim 1.

17. The nutrition bar of claim 1 wherein the nutrition bar is a fasting-mimicking ‘meal replacement’ bar or a fasting-mimicking ‘light meal’ bar that can replace breakfast, lunch or dinner.

18. A method of intermittent fasting comprising:
fasting by a subject for 12 up to 24 hours only intaking a nutrition bar for a predetermined number of meals, the nutrition bar comprising:
macadamia nuts;
honey;
pecans;
almonds;
almond butter,
coconut;
inulin;
cocoa derivatives;
flax seeds; and
coconut flour, the nutrition bar provides from 100 to 300 kcal of which 40 percent kcal are from fats and 10 to 30 percent kcal are from carbohydrates with less than 10 grams of protein.

19. The method of claim 18 wherein the predetermined number of meals is 1, 2, or 3 meals.

20. A method comprising:
identifying a subject in need of a fasting-mimicking diet; and
providing the subject with the fasting-mimicking diet having less than about 10 percent calories from protein sources, the fasting-mimicking diet providing at most 50% of the normal caloric intake of the subject with at least 50% of kilocalories provided being derived from fat, wherein the fasting-mimicking diet includes a nutrition bar, the nutrition bar comprising:
macadamia nuts;
honey;
pecans;
almonds;
almond butter,
coconut;
inulin;
cocoa derivatives;
flax seeds; and
coconut flour, the nutrition bar provides from 100 to 300 kcal of which 40 percent kcal are from fats and 10 to 30 percent kcal are from carbohydrates with less than 10 grams of protein.

21. The method of claim 20 wherein the fasting-mimicking diet provides the subject with from about 300 to 1200 kcal per day.

22. The method of claim 20 further comprising monitoring glucose and/or IGF-1 levels of the subject.

23. The method of claim 20 wherein the fasting-mimicking diet is administered to the subject for a first time period from 1 day to 14 days.

24. The method of claim 23 wherein the fasting-mimicking diet provides from 3 to 7 kilocalories per pound of the subject.

25. The method of claim 23 further comprising administering a second diet to the subject for a second time period following the fasting mimicking diet wherein the second diet provides an overall calorie consumption that is within 20 percent of a subject's normal calorie consumption for 25 to 26 days.

26. The method of claim 20 wherein the fasting-mimicking diet includes an amino acid specific supplement.
